(19) United States
(12) Patent Application Publication
(10) Pub. No.: US 2008/0159362 A1
(43) Pub. Date: Jul. 3, 2008

(54) SYSTEM AND METHOD FOR ADAPTIVE MODULATION AND POWER CONTROL IN A WIRELESS COMMUNICATION SYSTEM

(75) Inventors: Peter P. Gelbman, Kirkland, WA (US); Scott W. Jacka, Redmond, WA (US)

Correspondence Address: DAVIS WRIGHT TREMAINE, LLP/Seattle, 1201 Third Avenue, Suite 2200, SEATTLE, WA, 98101-3045, US

(73) Assignee: Clearwire Corporation, Kirkland, WA (US)

(21) Appl. No.: 11/618,200

(22) Filed: Dec. 29, 2006

(51) Int. Cl. H04B 1/38

(52) U.S. Cl. 375/219

(57) ABSTRACT

A system for adaptive modulation and power control in a wireless communication system includes a downlink from a base station to a remote unit and an uplink from the remote unit to the base station. The base station incorporates adaptive modulation on the downlink while power control is not utilized. In contrast, the remote unit utilizes a fixed modulation level and power control to control transmit power levels. In an exemplary embodiment, the remote unit uses QPSK modulation. The header of uplink messages include data from the remote unit to instruct the base station which modulation level to utilize on downlink transmissions. This provides closed-loop, non-iterative modulation control. In an exemplary embodiment, the modulation selection data is included in all uplink messages so that adaptive modulation can be communicated on a frame-by-frame basis.

### BACKGROUND OF THE INVENTION

1. Field of the Invention

The present invention is directed generally to wireless communications and, more particularly, to a system and method for adaptive modulation and power control in a wireless communication system.

2. Description of the Related Art

Wireless communication systems have increased in operational capabilities and complexity. Early wireless systems, such as analog cell phone systems, had relatively simple power control and interference mitigation processes that provided satisfactory operation.

Wireless communication systems are increasingly common for communication with computer systems. Satisfactory operation of such wireless communication systems requires generally greater bandwidth and more sophisticated signal processing techniques. For example, power control on the uplink (i.e., transmissions from a remote unit to a base station unit) and downlink (i.e., communications from the base station to the remote unit) is relatively common. Those skilled in the art will appreciate that increased power for one user may result in increased interference for another user. Thus, power control must be selectively applied to maximize overall system performance.

Another example of increased complexity in wireless communication signal processing is adaptive modulation, also known as link adaptation. With adaptive modulation on the uplink and downlink, it is possible to alter the selected modulation type based on measured characteristics. For example, if the measured characteristics indicate a good quality signal connection, the modulation level may be increased, thus increasing the number of data bits transmitted per symbol. In contrast, if external characteristics indicate a poor connection, it is possible to use a lower level of modulation to thereby insure greater reliability of reception despite the tradeoff in the number of data bits per symbol. Thus, the modulation level is adaptively altered based on the measured characteristics.

Modern communication systems utilize power control and adaptive modulation on both the uplink and downlink. However, these two parameters are not completely independent. Changes in one parameter may cause difficulty in adjusting the other parameter. Accordingly, it can be appreciated that there is a significant need for a system and method of adaptive modulation and power control in a wireless communication system that eliminate the co-dependence. The present invention provides this, and other advantages, as will be apparent from the following detailed description and accompanying figures.

### BRIEF DESCRIPTION OF THE SEVERAL VIEWS OF THE DRAWING(S)

FIG. 1 is a graph illustrating examples of the size of data transmissions in uplink traffic.

FIG. 2 is a graph illustrating examples of the size of data transmissions in downlink traffic.

FIG. 3 is a simplified system diagram of wireless communication system constructed in accordance with the present teachings.

FIG. 4 is a functional block diagram of a base station controller of the system of FIG. 3.

FIG. 5 is a functional block diagram of a consumer premise equipment (CPE) of the system of FIG. 3.

FIG. 6 is a graph illustrating the performance of a base station under near-ideal conditions.

FIG. 7 is a graph illustrating the performance of a base station in the presence of co-channel interference.

FIG. 8 is a graph illustrating the performance of a base station in the presence of co-channel interference and external interference.

### DETAILED DESCRIPTION OF THE INVENTION

The technology disclosed herein introduces concepts that may be applied to an airlink protocol for the purpose of improving overall system performance. As will be described in greater detail below, the processes includes a simple downlink adaptive modulation architecture and algorithms to realize maximum performance that works in conjunction with a form of uplink power control which is used to reduce system noise and inter-cell co-channel interference. The methods described allow a base station (BS) and consumer premise equipment (CPE) to monitor internal and external channel conditions, communicate these events rapidly to each other, and respond to such conditions.

As will be described in greater detail below, the improved uplink RF link budget allows the system to support a CPE implemented as a PC card rather than requiring an external CPE.

To better understand the proposed system in proper context, it is desirable to first discuss some underlying system level concepts regarding power control, link adaptation, and related issues of interference, channel conditions, etc.

### Power Control

Limiting radio transmit power, typically referred to as “power control,” is a well understood concept, fundamental to the basic operation of any cellular radio system. It is the first and most rudimentary interference mitigation technique employed by all modern cellular-type radio technologies. Various communications technologies, such as TDMA, GSM, CDMA, 802.11, and 802.16e WiMAX systems, use some form of power control for minimizing co-channel and adjacent channel interference. Early power control mechanisms within digital cellular systems all essentially focused on open-loop power control to limit transmit power levels based on received signal strength indication (RSSI) values and some form of channel bit-error-rate (BER).

Over time, many modern cellular technologies realized that power control schemes based on the received values for symbol error rate (SER) or RSSI yield relatively poor performance and have migrated to closed loop strategies which make use of more advanced channel estimation techniques and fast feedback control channels in the radio protocol structure for more granular and adaptive power control.

This is particularly true for mobile systems. It is known that CDMA technology is particularly interference limited, and were the first systems to widely implement more advanced forms of channel estimation, whereby qualitative channel measurements could be derived such, as Signal-to-Noise+Interference (SINR).

Contention based packet radio broadband wireless architectures are by definition extremely uplink interference limited. Interference is directly related to MAC efficiency and overall system performance under load. Effective power control requires accurately calibrated RF hardware and granular control of transmit power levels. For these reasons power control within broadband wireless systems typically employ sophisticated hardware/software and SINR-based, closed-loop mechanisms.

### Link Adaptation

In packet radio broadband wireless systems, link adaptation has emerged as an important technique to maximize radio performance under varying RF channel conditions. The fundamental concept behind link adaptation is to match the radio link to an optimal modulation level, based on the currently available SNR (SINR) of the channel. In this way the radio system becomes “adaptive” in that it may provide consistently optimal performance by responding to a dynamically changing RF environment. Most of the variations and impairments in a non-line of sight (NLOS) mobile radio channel are “bursty” in nature, (i.e., they occur for short durations and vary rapidly over time). For a link adaptation scheme to be effective it needs to be able to measure the quality of the radio channel quickly and accurately, and be capable of quickly changing the modulation level. Truly responsive link adaptation schemes require support in the radio protocol in order to perform these channel measurements and the ability to communicate this information efficiently between the BS and MS. Adaptive modulation schemes that can perform these functions very rapidly are somewhat proactive in that they are capable of detecting channel variations and responding at a rate that minimizes symbol errors.

### Building Blocks

Power control and link adaptation typically utilize two types of control strategies. Open-loop control is an iterative mechanism that makes adjustment decisions incrementally based on progressive performance that one side of the communication channel is able to discern. Closed-loop makes adjustments based on specific feedback messages between both sides of the communications channel. Closed-loop control is inherently more accurate and rapidly converging, thus is by far the preferred strategy in wireless systems.

Power control and link adaptation have subtle interactions with each other that must be properly considered in the system design. Power control ideally attempts to hold the RF power to the minimal levels required to maintain a required target SINR level. Link adaptation ideally tries to find the optimal modulation level based on the current SNR (SINR) of the channel. If improperly implemented, these features can wreak havoc on each other. Typically, power control must be managed first, and then transceiver modulation levels can be adjusted. However, both schemes may operate on fairly granular increments of SINR values and since it is desirable for both of these features to be capable of fast operation in order to accommodate rapid channel variations and impairments, these features must be carefully designed to work in concert with each other. Typically, the control loop algorithms for both features include advanced heuristics and hysteresis to ensure stable operation and maximum performance.

The following foundational building blocks are important for sophisticated power control, link adaptation, and many advanced PHY and MAC features within broadband wireless systems:

Channel estimation. Radio hardware/protocol/system design to provide accurate receiver measurements of frequency, timing, SNR and SINR.

Fast feedback channels. BS-MS RLC (Radio Link Control) protocol messaging to share channel quality information with each other. Desirable features of fast feedback channels:

Frequent messaging so control feedback loops can accommodate very rapid channel variations. Ideally, control information will be exchanged using header fields within each downlink and uplink frame.

Minimal control protocol overhead to maximize user data payload bandwidth. While control messaging should be fast, there is a tradeoff—it should use the bare minimum of data bits and should avoid encroaching on user payload data fields wherever possible.

Some existing communications systems are implemented with hardware and software that does not provide the capability to perform advanced channel estimation, thus no qualitative SINR or even SNR channel measurements are possible. In such systems, often only simplistic radio measurements are available such as RSSI and SER, which may not be very coarse and un-calibrated.

Furthermore, the airlink protocol in some wireless systems may not be structured to provide fast control feedback control channel messaging. In an orthogonal frequency division multiplexing (OFDM) system, there may be no spatial or frequency diversity, other than that provided by the OFDM airlink. It is well understood that any wireless channel will experience fades and big changes in signal quality for which adaptive modulation cannot compensate. Issues such as wind/foliage variations have been well characterized. Adaptive modulation techniques can typically accommodate ˜6 db SINR swings. However, RF fades can vary the channel by as much as 30 dB or more. Channel impairments due to fading conditions are not properly addressed with either adaptive modulation or power control. The scheme described herein makes no attempt to manage for dispersion (foliage, wind etc), and fast fading issues common to both fixed and mobile radio channels. These issues require frequency and space diversity in the system and must be dealt with separately.

It is known that OFDM systems can be very susceptible to external uplink interference sources that are prevalent in many regions that have significant number of users and are expected to become worse. Some communication systems have no mechanisms to detect, discriminate, or mitigate internal or co-channel interference events.

Given the constraints of the some wireless communications system architectures, it becomes challenging to design power control and adaptive modulation mechanisms that can perform well together under the real world channel conditions.

### Current Adaptive Modulation Control Mechanisms

In the absence of SINR channel quality measurements, some adaptive modulation algorithms can only operate using SER as triggering quality metric. Such algorithms may shift adaptive modulation levels in a slowly iterative open-loop fashion that are based on the amount of failed messages reported by the CPE. Often the downlink channel may perform much better than uplink. Depending on traffic patterns, the CPE may not generate enough data to trigger adaptive modulation to shift down to a lower modulation level. In these cases, the system tends to stay at a modulation level that is too high for reliable communications on the uplink. In bursty traffic situations this leads to very unstable, intermittent performance. In a wireless IP network should this happen during initial DHCP requests, the host PC may fail to communicate at all.

Such adaptive modulation algorithms have little ability to discriminate between the many possible types of channel impairments that may cause an increase in SER. In a loaded sector experiencing contention, even in good RF conditions, the CPE will experience failed uplink transmissions. Optimization of adaptive modulation in both link directions under various non-reciprocal SER conditions is nearly impossible in a contended uplink environment.

### Current Uplink Adaptive Modulation Performance

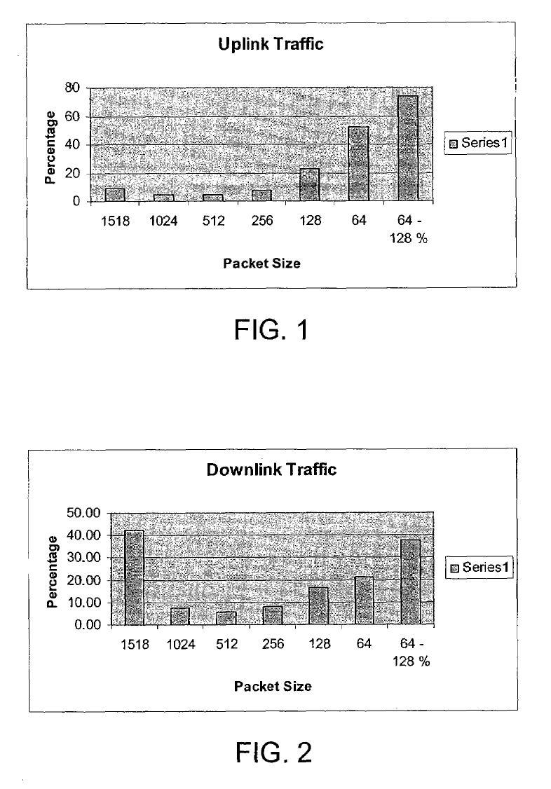

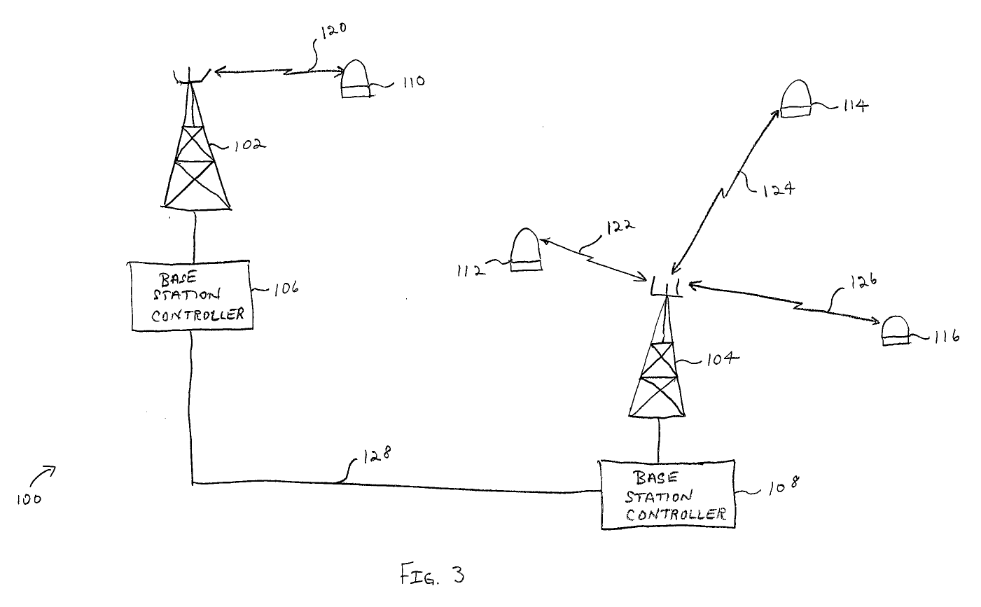

In real-world uplink Internet traffic patterns, 70-80% of packets are very small, with 50% of the packets comprising 60 byte transmission control protocol (TCP) Ack frames. FIGS. 1 and 2 are graphs that show actual uplink and downlink packet size distributions from an actual commercial wireless IP network with adaptive modulation features. In the example of FIG. 1, 60 bytes is the size of the system uplink QPSK message length. This means that for 50% of all uplink traffic, modulation levels higher than QPSK offer more bytes per symbol/slot are absolutely no advantage.

Throughout the wireless network, on average we see roughly 25% of all CPEs have QPSK modulation. This means that for the 50% of total frames in the network that are larger than 60 bytes and would potentially benefit from higher modulation levels—only 75% of those will actually have the link budget, or channel quality to achieve a higher modulation level anyway.

In this example, the system is an L2 Ethernet bridge that is architected to forward each uplink Ethernet frame with minimal latency—it does not do stream based queuing, or “byte stuffing”. For this reason even if the radio channel is capable of performing at a higher modulation level, the extra available bandwidth is actually often wasted and the RF power used to deliver it is unnecessary.

Downlink adaptive modulation does not suffer from these same issues. As illustrated in the packet size chart of FIG. 2, a large percentage of downlink packets are large, and can take good advantage of increased slot or frame size offered by higher modulation levels. Since the BS processes packets for many CPEs, it can also do some “byte stuffing” to optimize payload for higher modulation levels.

### Unlink Adaptive Modulation and RF Link Budget Relationship

In the example communications system described above, modulation levels have the following receive sensitivity requirements:

| | |
|---|---|
| QPSK ½ rate CC | 95 dBm |
| 16QAM ½ rate CC | 90 dBm |
| 64QAM ½ rate CC | 80 dBm |
| 16QAM no CC | 75 dBm |

The term “CC” refers to convolutional coding, which is known in the art and need not be described herein. The use of various modulation levels within the communications network vary greatly per sector and over time, but a general approximate average is approximately:

| | |
|---|---|
| QPSK ½ rate CC | 30% |
| 16QAM ½ rate CC | 20% |
| 64QAM ½ rate CC | 30% |
| 16QAM no CC | 20% |

This means that the QPSK ½ modulation level and the 64QAM ½ modulation levels are each selected approximately 30% of the time while the 16QAM ½ and 16QAM with no CC modulation levels are each selected approximately 20% of the time.

To help illustrate and summarize the real world adaptive modulation and RF power issues within a typical wireless system, Table 1 below shows the throughput efficiency levels seen by each adaptive modulation symbol per uplink timeslot to transmit a single 60-byte TCP Ack: message.

TABLE 1
Airlink efficiency

| | | Uplink | | | | |
|---|---|---|---|---|---|---|
| | Net | Symbol | | | | Link budget |
| | work | throughput | TCP Ack | BW | Rx Sensitivity | requirement |
| Modulation | Dist | bytes | bytes | Efficiency | Requirement | delta vs. QPSK ½ |
| QPSK ½ rate CC | 30% | 60 | 60 | 100% | −95 dBm | — |
| 16QAM ½ rate CC | 20% | 134 | 60 | 55% | −90 dBm | 5 dB |
| 64QAM ½ rate CC | 30% | 208 | 60 | 29% | −80 dBm | 15 dB |
| 16QAM no CC | 20% | 288 | 60 | 21% | −75 dBm | 20 dB |

Table 1 shows that in the current wireless communications system, transmitting small Ethernet frames at higher modulation levels is very inefficient both in terms of bandwidth utilization and link budget (energy-per-bit). The 16QAM presents the obvious worse case example: ˜50% of all uplink packets for 20% of the subscribers are wasting 79% of their bandwidth, and for each airlink frame used to do this they are wasting 20 dB of link budget RF power.

Since TCP traffic is the predominant uplink traffic type (70-80%), these issues have serious ramifications to overall system performance. With above considerations, if the system uplink were to be limited to only QPSK, the system could enjoy the following uplink power reductions:

5 dB less for 20% of total subscribers

10 dB less for 30% of total subscribers

20 dB less for 20% of total subscribers.

Those skilled in the art will appreciate that the overall uplink power reductions offered by this scheme are 5-20 dB for ˜70% of the subscribers on the system.

### Design Overview

This design attempts to tailor a pragmatic strategy to improve overall system performance and efficiency by implementing a form of closed-loop uplink power control that works in conjunction with an improved approach to downlink adaptive modulation.

In the example embodiment of a simple TDD packet radio architecture with a simple Slotted Aloha MAC, a contended uplink is fundamentally an uplink interference limited system. In such a system, downlink power control is a nice, but non-critical feature, because intra-cell and inter-cell co-channel interference issues primarily dominate the contended uplink channel.

As previously discussed, uplink adaptive modulation in some system architectures has somewhat limited effectiveness. Other modern wireless technologies that implement adaptive modulation such as EDGE, HSPDA, and WiMAX recognize that the uplink performance is a limiting factor and constrain uplink to use lower modulation levels and/or heavier channel coding for these reasons.

As previously discussed, some wireless communication systems have a radio architecture that does not include precise channel estimation and qualitative channel measurement capabilities. In these systems, RSSI is the only direct radio measurements available, and these may not be very accurate. As a result, we accept that any form of power control implementation in such a system will be relatively coarse.

With the above considerations, FIG. 3 illustrates a system 100 constructed in accordance with the present teachings. The system 100 includes a base station (BS) 102 and a BS 104. The BS 102 is controlled by a base station controller 106 while the BS 104 is controlled by a base station controller 108.

Also illustrated in FIG. 3 are a plurality of consumer premise equipment (CPE) 110-116. In the example illustrated in FIG. 3, the CPE 110 communicates with the BS 102 via a wireless communication link 120. The CPEs 112-116 are illustrated in FIG. 3 as communicating with the BS 104 via wireless communication links 122-126, respectively.

In addition, FIG. 3 illustrates a communication link 128 coupling the base station controller 106 and the base station controller 108. In a typical embodiment, the communication link 128 may also be coupled to a system-wide controller (not shown), which may control operations at one or more base stations. Those skilled in the art will appreciate that the simplified diagram of FIG. 3 only includes two base stations and four CPEs. In a typical embodiment, the system 100 would include many more base stations and many more CPEs coupled to each base station. However, for purposes of explanation of the system 100, the simplified system diagram of FIG. 3 will suffice.

With the system 100, there is a system level decision to run the system with adaptive modulation operating only on the downlink and power control operating only on the uplink (or conversely, no adaptive modulation on the uplink and no power control on the downlink). With this system configuration, subtle interactions and complexities between adaptive modulation and power control are avoided since the two features do not operate together in either downlink or uplink direction simultaneously. Furthermore, this approach enables us to implement a unique and simple hybrid closed loop control system that uses the downlink modulation level to determine proper uplink transmit power. Uplink CPE transmit power levels can be lock-stepped in a continuous control loop that is essentially controlled by downlink SER under reciprocal channel conditions. In this scheme, downlink modulation levels are optimized at all times while CPE uplink transmit power is kept reasonably minimal at all times. Several mechanisms have been defined to handle critical non-reciprocal channel conditions such as inter-cell co-channel interference and external uplink interference.

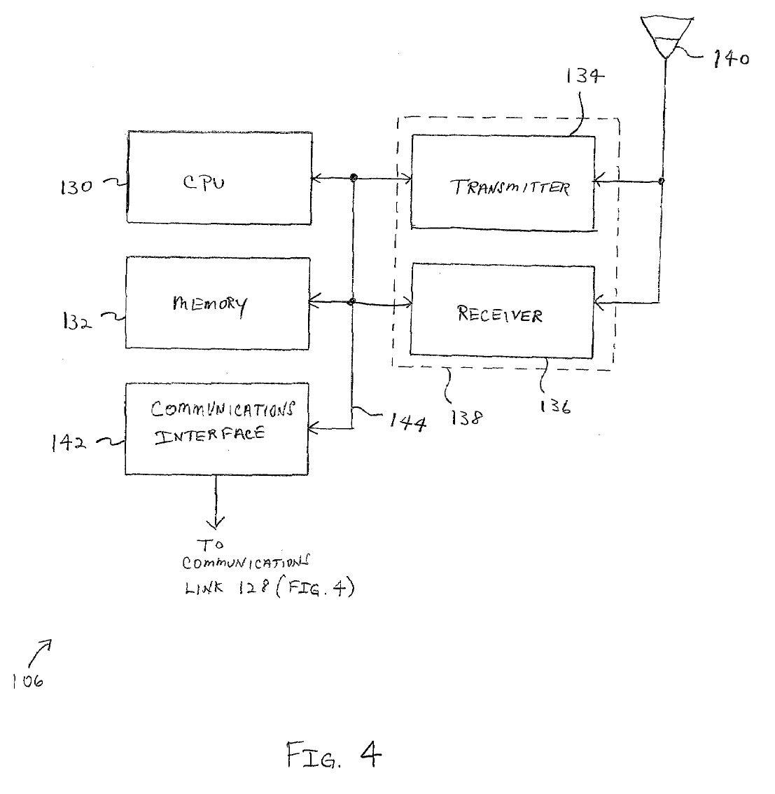

FIG. 4 is a functional block diagram illustrating an example of a base station controller, such as the BSC 106. Operation of the BSC 108 is essentially identical to that of the BSC 106.

The BSC 106 includes a central processing unit (CPU) 130 and a memory 132. The CPU 130 may be implemented by any number of known technologies. For example, the CPU 130 may be a microprocessor, microcontroller, application specific integrated circuit (ASIC), or the like. The system 100 is not limited by the specific implementation of the CPU 130.

Similarly, the memory 132 may be implemented by any number of known technologies. The memory 132 may include dynamic memory, static memory, flash memory, or the like. In one embodiment, a portion of the memory 132 may be integrated into the CPU 130. The system 100 is not limited by any specific implementation of the memory 132.

In general, the memory 132 provides data and instructions for execution by the CPU. The CPU 130 and memory 132 function together to encode data for transmission and to decode received data.

The BSC 106 includes a transmitter 134 and a receiver 136. The transmitter 134 and receiver 136 may share common circuitry and be implemented as a transceiver 138. The transmitter 134 is capable of multiple forms of modulation, as described above. While the transmitter 134 is also capable of transmitting at a plurality of power control levels, the system 100 does not implement power control on the downlink. The transmitter 134 transmits data to one or more CPEs (e.g., the CPE 110 in FIG. 3). The operational details of the transmitter 134 and receiver 136 is well known in the art and need not be described in greater detail herein.

The transmitter 134 and receiver 136 are coupled to an antenna 140. Those skilled in the art will appreciate that the antenna 140 generally comprises one or more directional antenna components that each provide a coverage range in a specific sector or direction from the base station (e.g., the BS 102). In other implementations, the BSC 106 has a separate transmitter 134 and receiver 136 for each sector. Thus, each sector has its own transmitter 134, receiver 136, and antenna 140. However, for the sake of simplicity, the BSC 106 is illustrated in FIG. 4 as having a single transmitter 134 and single receiver 136 coupled to a single antenna 140.

FIG. 4 also illustrates a communications interface 142 that couples the BSC 106 to the communications link 128 of FIG. 3. The communications interface 142 may be a conventional network interface adapter, such as an Ethernet interface, or the like. Operation of the communications interface 142 is known to those skilled in the art and need not be described in greater detail herein.

The various components illustrated in the functional block diagram of FIG. 4 are coupled together by a bus system 144. The bus system 144 may include an address bus, data bus, control bus, power bus, and to the like. For the sake of simplicity, those various busses are illustrated in FIG. 4 as the bus system 144.

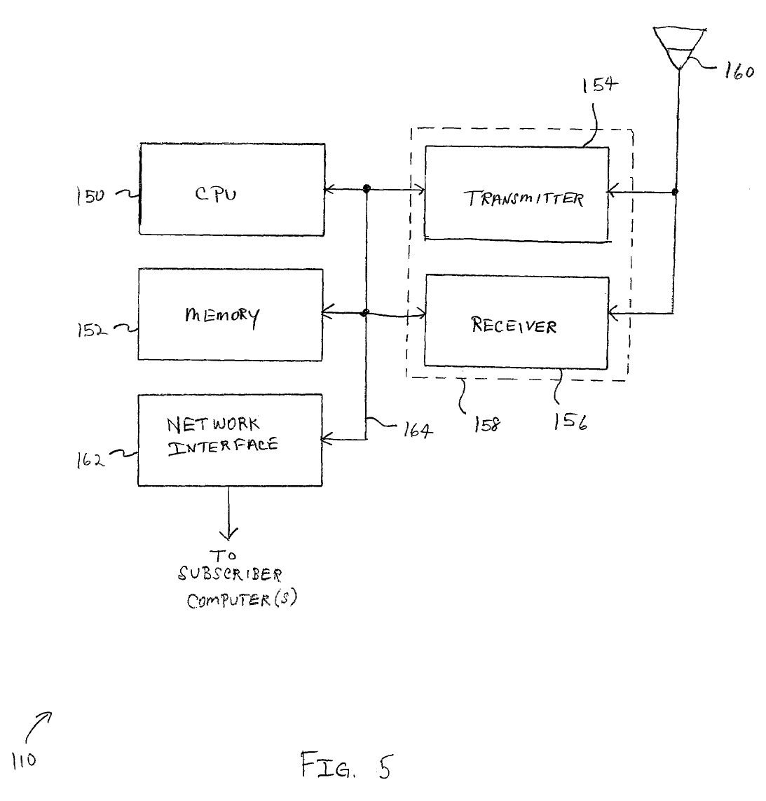

FIG. 5 is a functional block diagram illustrating the operation of a CPE, such as the CPE 110 of FIG. 3. Operation of other CPEs are essentially identical to that of the CPE 110.

The CPE 110 includes a central processing unit (CPU) 150 and a memory 152. The CPU 150 may be implemented by any number of known technologies. For example, the CPU 150 may be a microprocessor, microcontroller, application specific integrated circuit (ASIC), or the like. The system 100 is not limited by the specific implementation of the CPU 150.

Similarly, the memory 152 may be implemented by any number of known technologies. The memory 152 may include dynamic memory, static memory, flash memory, or the like. In one embodiment, a portion of the memory 152 may be integrated into the CPU 150. The system 100 is not limited by any specific implementation of the memory 152.

In general, the memory 152 provides data and instructions for execution by the CPU. The CPU 150 and memory 152 function together to encode data for transmission and to decode received data.

The CPE 110 includes a transmitter 154 and a receiver 156. The transmitter 154 and receiver 156 may share common circuitry and be implemented as a transceiver 158. The transmitter 154 is capable of operation at a plurality of power control levels. Although the transmitter 154 is capable of multiple forms of modulation, the system 100 does not utilize adaptive modulation on the uplink. Rather, the transmitter 154 is configured for operation using QPSK. The transmitter 154 transmits data to its designated base station (e.g., the BS 102 in FIG. 3). The operation of the transmitter 154 and receiver 156 is well known in the art and need not be described in greater detail herein.

The transmitter 154 and receiver 156 are coupled to an antenna 160. The antenna 160 is typically a small internal directional antenna to allow simple installation and operation by a user.

FIG. 5 also illustrates a network interface 162. The network interface 162 allows the CPE 110 to communicate with one or more subscriber computers (not shown). In a typical implementation, the network interface may be a conventional network interface adapter, such as an Ethernet interface. If the network interface 162 is coupled to a plurality of computers, the CPE 110 may also include the functionality of a router. In this manner, data may be routed individually to the various computers coupled to the CPE. Operation of the CPE as a router is known in the art and need not be described in greater detail herein.

The various components illustrated in the functional block diagram of FIG. 4 are coupled together by a bus system 164. The bus system 154 may include an address bus, data bus, control bus, power bus, and to the like. For the sake of simplicity, those various busses are illustrated in FIG. 5 as the bus system 164.

Adaptive modulation is removed from uplink. Thus, the transmitter 154 in the CPE 110 uses QPSK modulation at all times. This introduces more reliability and stability on the uplink. The use of QPSK as the only modulation option provides for reduction in uplink transmit power directly proportional to the reduced SINR requirement of the channel.

Downlink modulation level is now selected based on feedback messages transmitted from the CPE 110 to the BS 102 in each uplink frame. As will be discussed in greater detail below, the airlink protocol includes fast-feedback control channel protocols that operate in-band within each frame header on downlink and uplink. These feedback channels facilitate rapid, non-iterative closed-loop adaptive modulation on the downlink, and rapid, non-iterative closed-loop power control on the uplink. With the implementation of the system 100, the downlink modulation and uplink power control operate in concert with each other on a frame-by-frame basis.

The system 100 now has closed-loop uplink power control, triggered by downlink modulation level. The transmit power of the transmitter 154 in the CPE 110 is kept at minimal levels at all times to minimize uplink co-channel cellular interference. When co-channel interference is detected, the transmitter 154 in the CPE 110 is held at minimal power regardless of the downlink modulation level. If external uplink interference is detected, power control may be overridden to permit full power CPE transmission in order to maximize uplink SINR.

The system 100 measures channel conditions, and monitors for external co-channel interference and inter-cell co-channel interference. The BS and CPE are able to communicate nearly real-time and respond to these conditions. Several practical mechanisms are described below for each condition. The following sections describe the implementation details of the design of the system 100.

### Channel Condition Modes

The system 100 includes Downlink and Uplink Channel Condition “modes”. These modes are simply a method for describing various channel states that will be used within the adaptive modulation and power control loop logic decisions that are described below.

### Downlink Channel Condition (DCC)—Two “modes”:

1. “Normal” mode.

2. “Co-channel RFI” mode—this is defined when the CPE 110 measures both RSSI and SER to be high. In this scenario, the received signal appears to be adequate (i.e., the RSSI is high), but there are errors (i.e., SER is high). The presumption is that errors are being caused by co-channel RFI. Those skilled in the art will recognize that the precise threshold criteria for each (i.e., RSSI and SER) can be determined without the exercise of undue experimentation.

It should be noted that, although this is a downlink channel mode, we use this indicator to determine co-channel RFI status, which is assumed to be non-reciprocal on uplink and downlink between a CPE, and its desired BS. In other words, if the CPE 110 is taking downlink interference from an undesired BS (e.g., the BS 104), it must be also causing uplink interference to that BS. This condition is easier to detect on downlink via the CPE, so it can be referred to herein as a DCC. In practice, co-channel RFI is primarily detrimental on the contended uplink. The co-channel RFI mode is used primarily for mechanisms to reduce uplink CPE transmit power levels.

### Unlink Channel Condition (UCC)—Two “modes”:

1. “Normal” mode.

2. “External Uplink Interference” mode—this is defined when BS is able to discern external uplink interference events. Several techniques are possible for the BS to accomplish this.

For example, the BS 102 measures a high RSSI and a high SER and no uplink adaptive modulation level change requests from the CPE 110, this could indicate external uplink interference. Those skilled in the art will recognize that the precise threshold criteria for each (i.e., SER and RSSI) can be determined without the exercise of undue experimentation.

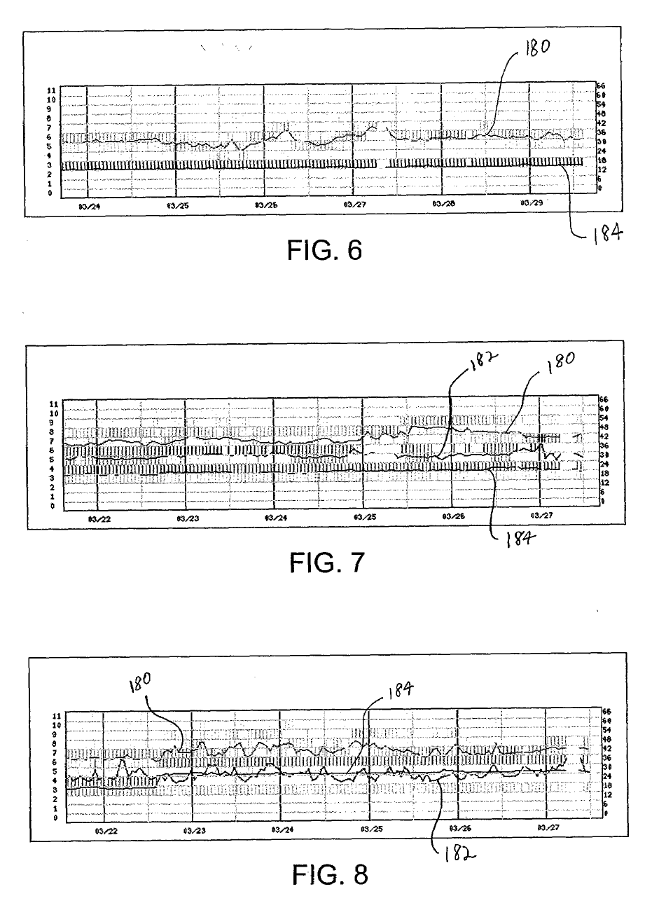

In the presence of external uplink interference, the BS decodes symbols from each CPE that is destined for it, as well as those from CPEs located in adjacent co-channel sectors. In general, it is possible to infer internal and external interference levels by examining statistical counters of various types of received (decoded) and corrupted symbols, their ratios, signal power levels, and relationship to the BS receive noise floor. The graphs of FIGS. 6-8 illustrate these concepts. It should be noted that the graphs of FIGS. 6-8 are currently generated by external analysis tools that operate on historical BS log data. However, the same control logic could be performed within the CPU 130 (see FIG. 4) itself during real-time operation.

In these examples, a curve 180 represents the desired signal, a curve 182 represents co-channel, and a curve 184 represents is external noise. The higher the trend line, the stronger the signal. These are measurements made over time. In the ideal case, the curve 180 should be on top, the curve 186 as low as possible and the curve 184 non-existent.

FIG. 6 illustrates data for an ideal site. The curve 184 is about as low as it can get, indicating no external interferers. This is called the noise floor. Also note that there is no curve 182 present in FIG. 6, indicating that there is no measurable co-channel interference.

FIG. 7 illustrates results for a site that is being affected by co-channel interference. The curve 182 (co-channel interference) is almost as strong as the curve 180 (desired signal).

FIG. 8 illustrates results for a site that is being affected by external interference in addition to co-channel interference. The curve 182 (co-channel interference) are almost as strong as the curve 180 (desired signal). In addition, the curve 184 (external interference) are almost as strong as the curve 180 (desired signal).

### Airlink Protocol Implementation

The following sections describe an exemplary airlink uplink and downlink protocol structure to facilitate fast feedback control protocols.

Those skilled in the art will recognize that a typical protocol will include a plurality of data fields. The examples provided herein serve to illustrate the basic protocol structure necessary to implement the system 100. Other implementations are possible.

### Fast Feedback Control Channel Protocols

As described earlier in this document, fast-feedback control messaging protocols are the building blocks required to implement effective adaptive modulation and power control schemes. The following sections introduce two simple fast feedback control protocols. Detailed implementation and operation of each within the context of adaptive modulation and power control are detailed later sections.

### UAMI (Uplink Adaptive Modulation Indicator)

We want to optimize downlink adaptive modulation to make it fast and reliable with minimal processing overhead. To do this we want a protocol for the CPE to continuously, rapidly, and reliably tell the BS on uplink which modulation level the CPE wants to receive on downlink. An uplink message typically comprises a header portion and a data or payload portion. The UAMI protocol is implemented in the header portion of all uplink slot messages. This allows the desired modulation level to be communicated on a frame-by-frame basis and permits the modulation level to be rapidly ratcheted up and down in response to varying channel conditions.

As previously discussed, the system 100 may implement one of four selected modulation levels. Those skilled in the art will appreciate that the four modulation levels may be represented by two data bits. Additional modulation levels may require the introduction of more than two data bits. However, Table 2 below indicates the modulation level selection and data bits that are added to each uplink slot message.

TABLE 2
Modulation Level Selection Data

| Modulation Level | Header Data Bits |
|---|---|
| QPSK ½ CC | 00 |
| 16QAM ½ CC | 01 |
| 64QAM ½ CC | 10 |
| 16QAM no CC | 11 |

Those skilled in the art will appreciate that messages in the uplink may fit within a single time slot or require multiple slots. However, the typical header on both initial slots and additional packets in a multiple slot message all have sufficient data bits available in the header to allocate two data bits for use as the UAMI. The specific implementation details are well within the scope of knowledge of one of ordinary skill in the art.

Those skilled in the art will further appreciate that a multi-slot message typically includes header data in the initial slot message to indicate the size of the message (i.e., the number of concatenated multi-slot messages). The base station (e.g., the BS 102 in FIG. 3) decodes the initial uplink slot message and can determine the number of additional slots allocated to this message. In addition, the base station receives data indicating the frame length. This data may be contained in the initial slot or in a subsequent slot. Given that the transmitter 154 (see FIG. 5) of the CPE 110 only uses QPSK modulation, the base station can calculate the Ethernet frame link in bytes. With the reception of each and every time slot message, the base station is told, via the UAMI data bits which modulation level to use for the next downlink slot for that particular CPE. Thus, the system 100 provides a simple high speed, non-iterative adaptive modulation control mechanism.

CPE no longer uses adaptive modulation on uplink. CPE transmits using QPSK modulation at all times. With the UAMI (Uplink Adaptive Modulation Indicator) protocol of Table 2, the CPE 110 is capable of telling BS 102 (see FIG. 3) which modulation level to use on a frame-by-frame basis. The CPE 110 measures SER over a very short window of frames and can now tell the BS 102 immediately to ratchet the modulation level up or down accordingly. For example, the CPE 110 could maintain a simple running average SER over last N frames (i.e., N=50 or 100), and a predetermined SER %, (i.e., 1%) to trigger downshift in the modulation level, and a predetermined decrease of SER to shift the modulation level back up. Since the CPE 110 transmit is always locked at QPSK, the uplink UAMI messages always have maximum reliability to get through.

Triggered via reliable and extremely fast UAMI messages in each frame, downlink modulation is truly “adaptive” in the sense that it can rapidly shift down to accommodate transient, bursty RF channel impairments and rapidly shift back up as soon as channel conditions improve—with no overhead to do so. That is, it is not necessary to transmit a specific modulation selection message; the UAMI is part of an uplink message being routinely sent to the BS.

Maximum adaptive modulation efficiency is realized for downlink where it matters, and uplink adaptive modulation complexities are avoided—since they don't offer much benefit anyway. The requirement for complex, slowly iterative modulation shifting algorithms that are difficult to properly optimized in order to discriminate and accommodate all types of downlink/uplink SER issues—is completely eliminated.

In accordance with the UAMI protocol described above, two data bits are allocated to UAMI and transmitted with every uplink slot message. In some traffic scenarios where there is only downlink data flowing from BS towards the CPE, then clearly no uplink frames are being sent and UAMI will not be able to operate. An example of this scenario is a subscriber downloading a streaming media application, using only UDP packets. In this scenario, if channel errors are detected on downlink by the CPE, then the CPE has no mechanism for sending a UAMI message. However, the system 100 addresses this scenario by utilization of a modulation message. The modulation message may specifically request a certain modulation level. Alternatively, the modulation message may include UAMI data bits as described above. Although this approach requires additional overhead to transmit the modulation request message, this scenario does not occur frequently and is tolerant of occasional disruption of downlink messages to process the uplink modulation request message.

In practical implementation, UAMI control messaging could be used to address the above issue, but in cases where there is no uplink user traffic flowing and the downlink modulation level needs to be changed, the CPE must know to generate some sort of uplink frame to convey the UAMI message. This latter functionality could be provided by a modulation request message.

### Uplink Power Control

As previously discussed, example values for sensitivity requirements for the different modulation levels are:

| | |
|---|---|
| QPSK ½ CC | −95 dBm |
| 16QAM ½ CC | −90 dBm |
| 64QAM ½ CC | −80 dBm |
| 16QAM no CC | −75 dBm |

Ideally, the system 100 operates with a balanced link budget. The system 100 assumes that TDD RF channel has reciprocal radio characteristics for downlink and uplink under “normal” radio conditions (attenuation, shadowing, fading, etc). Since the CPE is always locked at QPSK modulation on the uplink, the amount of CPE uplink transmit power previously required to support each incrementally higher uplink modulation level can now be subtracted in proportion to the difference between QPSK and the currently active downlink modulation class (when downlink is using a modulation level greater than QPSK).

When downlink modulation level is QPSK, the CPE will use QPSK and transmit at its highest power, which is 30 dBm, by way of example. When downlink adaptive modulation is using 16QAM modulation, the CPE is now still using QPSK, but the CPE can use 5 dB less power and still maintain a balanced link budget. The value 5 dB is the Δ in SINR requirements between QPSK and 16QAM modulation, as shown in Table 1. In the case of 64Q on the downlink, the A between 64QAM and QPSK will be 15 dB. For 16QAML on the downlink, the Δ between 16QAML and QPSK will be 20 dB. Thus, the CPE may reduce power when the downlink is communicating at higher modulation levels and still maintain a balanced link budget.

Under DCC (Downlink Channel Condition) mode “A” (normal), and Under UCC (Uplink Channel Condition) mode “A” (normal), the uplink power control mode is fully enabled. In this mode, the CPE 110 selects transmit power level based on its received modulation level from the BS 102 on the downlink. If the BS 102 is using QPSK, then the CPE 110 will transmit at full power. With active power control, if the BS 102 is using 16QAM modulation on the downlink, then the CPE 110 will transmit less power because it assumes the receiver 136 (see FIG. 4) of the base station 102 is also capable of receiving at 16QAM. However, because the CPE 110 is actually using QPSK, the CPE may transmit at a lower power. Using the examples of Table 1, the CPE may reduce its transmit power by 5 dB.

Under DCC mode “B” (co-channel RFI), it is assumed that the CPE 110 is receiving co-channel RFI from another BS sector (e.g., from the BS 104) and also causing uplink interference to that same sector. In this mode, the CPE adaptive modulation SER measurement control logic executed by the CPU 150 in FIG. 5 will still instruct the desired BS (e.g., the BS 102) to lower downlink modulation level to assist with downlink C/I performance, but he will NOT increase his transmit power accordingly, since the higher power should not be needed on the reciprocal channel to the desired BS. This will enable a CPE in an inter-cell co-channel interference state to maximize his own receive performance from his intended BS, while minimizing his uplink interference contribution to the other un-desired BS.

Under UCC (Uplink Channel Condition) mode “B”, the BS measures external uplink interference and immediately communicates this to the CPE via the EUII fast feedback message in each downlink slot. When the CPE receives downlink slots with this flag set, it shall use maximum uplink transmit power, regardless of downlink modulation level. Effectively, EUII is used to disable uplink power control in the presence of external system interference to achieve maximum possible uplink C/I.

### PC Card Implications

An external CPE typically has a directional antenna, which provides some antenna gain and provides a stronger signal for transmission and reception of data. However, implementation of the CPE as a PC card product has link budget limitations and antenna considerations that may seriously impact its performance and performance of the wireless network on the whole.

The PC card CPE will often use a low gain, omni-directional antenna. Due to the reduced antenna gain compared to directional antenna CPE product, range and building penetration become serious performance issues. Although the antenna gain is lower, due to the omni directional uplink transmit radiation pattern the PC card product will contribute uplink interference to the network in geographical and directional ways that are avoided by a stand-alone implementation of a CPE.

For PC Card CPEs that are mobile, timing and frequency offset limitations may make it more difficult to achieve higher order modulation levels. However, the implementation of the system 100 fixes the modulation for the CPE. In this scenario, using QPSK in a PC implementation of the CPE has no negative impact on performance.

Given the above considerations, the adaptive modulation and uplink power control mechanisms described in the previous sections potentially offer the following system improvements for the PC card CPE:

PC Card CPEs that have a good radio link to the BS, the proposed uplink power control scheme will greatly reduce potential co-channel interference issues.

PC Card CPEs that have a poor radio link to the BS can make use of reduced modulation to achieve higher transmit power. In other words, in certain cases, PC cards may choose to not use power reduction in order to achieve better link performance (range). Obviously this could come at the expense of increased inter-cell uplink co-channel interference. This also introduces issues regarding a uneven link budget, but the BS has high power capabilities that could be used to balance this to some extent.

### Experimental Lab Test Data

### Adaptive Modulation Experiments

Experiments were performed in a controlled lab environment in order to investigate the theory that fixed QPSK modulation level on uplink will not have significant impact to overall system performance. Two subscriber loading scenarios were examined. In both scenarios, the performance of higher modulation schemes on uplink vs. QPSK uplink was analyzed. In all cases, HTTP downlink traffic was used. The following sections detail the test cases:

### 1. Light Subscriber Load, “Best Case” Modulation

This scenario looked at 5 CPEs; with both downlink and uplink configured at the highest modulation, 16QAM no CC. Test consists of all users repetitively downloading a file using HTTP. Test was repeated a 2^{nd} time with all parameters held the same, except with uplink locked at QPSK modulation.

Results:

| | | 5 CPE @ | |
|---|---|---|---|
| | 5 CPE @ | 16QAM no CC | |
| | 16QAM no CC | DL, QPSK ½ | |
| | DL & UL | CC UL | Delta |
| Avg tput per-CPE | 0.543 | 0.458 | 15.668% |
| Avg agg tput | 2.716 | 2.339 | 13.881% |

### 2. Heavy Subscriber Load, “Real World” Modulations

This scenario looked at 49 CPEs, with both downlink and uplink configured for a mix of modulation levels typically seen in the real world—30/20/30/20 as provided in the example data of Table 1. Test consists of all users repetitively downloading a file using HTTP. The test was repeated a 2^{nd} time with all parameters held the same, except with uplink locked at QPSK modulation.

Results:

| | 49 CPE @ | 49 CPE @ | |
|---|---|---|---|
| | 30/20/30/20 mod | 30/20/30/20 mod dist | |
| | Dist DL & UL | DL, QPSK ½ CC UL | Delta |
| Avg tput per-CPE | 0.068 | 0.060 | 11.765% |
| Avg agg tput | 3.221 | 3.209 | 0.372% |

### Analysis

Test results show that in light load and best case high modulation environment, individual subscriber HTTP downlink throughput experienced 16% degradation and aggregate 14% system wide degradation by moving to QPSK on uplink.

For the heavy load in a more real world modulation environment, individual subscriber HTTP downlink throughput experienced 12% degradation and aggregate system wide degradation of only 0.04% by moving to QPSK on uplink. These results support the theory that under heavy load, higher uplink modulation levels only offer marginal benefit to the system and that locking the uplink modulation to QPSK only may be a very acceptable trade-off in light of the significant power uplink power and intra-system interference reductions which may be realized from doing so.

### Summary

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. For example, the modulation levels discussed in the specification are commonly used in various telecommunication systems. However, the system 100 may be readily implemented using other modulation levels. Modulation levels associated with wideband high performance wireless systems are, by way of example, QPSK ½ CTC, QPSK ¾ CTC, 16 QAM ½ CTC, 16 QAM ¾ CTC, 64 QAM ½ CTC, 64 QAM ⅔ CTC, and 64 QAM ¾ CTC. The term “CTC” refers to convolution turbo coding, which is a type of forward error correction specified in WiMAX. This process is known in the art and need not be described in detail herein. Other modulation levels may also be implemented in accordance with the teachings herein. Therefore, the specific modulation level selected for operation is not a limitation in the present description.

Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A wireless communication system having a base station and a remote unit, the system comprising:
a base station transmitter configured to transmit data to the remote unit via a downlink, the base station transmitter capable of transmission using a plurality of modulation levels;
a remote unit receiver configured to receive the data transmitted by the base station transmitter via the downlink;
a remote unit transmitter configured to transmit data to the base station via an uplink, the remote unit transmitter capable of transmission at a plurality of transmitter power levels;
a base station receiver configured to receive the data transmitted by the remote unit transmitter via the uplink;
a base station controller configured to select a modulation level for the base station transmitter wherein the modulation level is adaptively altered, and the base station transmitter power level remains unchanged; and
a remote unit controller configured to select a transmitter power level for the remote unit transmitter wherein the remote unit transmitter power level is adaptively altered, and the remote unit modulation level remains unchanged.

2. The system of claim 1 wherein the base station transmitter modulation level is selected from a group of modulation levels comprising QPSK ½ rate CC, 16 QAM ½ rate CC, 64 QAM ½ rate CC, 64 QAM no CC, QPSK ½ CTC, QPSK ¾ CTC, 16 QAM ½ CTC, 16 QAM ¾ CTC, 64 QAM ½ CTC, 64 QAM ⅔ CTC, and 64 QAM ¾ CTC.

3. The system of claim 1 wherein the base station controller is configured to select one of the plurality of modulation levels based on data received from the remote unit.

4. The system of claim 3 wherein the base station receiver is configured to receive data from the remote unit transmitter on a plurality of occasions, the received data on at least a portion of the plurality of occasions including modulation selection data wherein the base station controller is configured to select one of the plurality of modulation levels based on the periodic modulation selection data received on at least one of the plurality of occasions.

5. The system of claim 3 wherein the base station is configured to receive a plurality of data frames transmitted by the remote unit, at least a portion of the plurality of data frames including modulation selection data wherein the base station controller is configured to select one of the plurality of modulation levels based on at least one of the plurality of data frames containing the modulation selection data.

6. The system of claim 5 wherein the base station controller is configured to adaptively select one of the plurality of modulation levels based on the modulation selection data received based on a most recently received one of the plurality of data frames.

7. The system of claim 1 wherein the remote unit comprises a consumer premise equipment (CPE).

8. The system of claim 1 wherein the remote unit controller is configured to determine an error rate of data received from the base station, the remote unit controller being further configured to select a modulation level for downlink transmissions based on the determined error rate.

9. The system of claim 8 wherein the error rate determined by the remote unit controller is a symbol error rate (SER).

10. The system of claim 8 wherein the remote unit transmitter is configured to transmit modulation selection data to the base station to select one of the plurality of modulation levels based on the determined error rate.

11. The system of claim 1 wherein the remote unit controller is configured to select one of the plurality of transmitter power levels for transmission of data on the uplink based on the selected one of the plurality of modulation levels used on the downlink.

12. The system of claim 1 wherein the remote unit controller is configured to decrease transmitter power level for uplink transmissions if the selected modulation level for the downlink increases.

13. The system of claim 1 wherein the remote unit controller is configured to increase transmitter power level for uplink transmissions if the selected modulation level for the downlink decreases.

14. A wireless communication system having a base station and a remote unit, the system comprising:
a base station transmitter configured to transmit data to the remote unit via a downlink, the base station transmitter capable of operation using a selected one of a plurality of modulation levels;
a remote unit receiver configured to receive the data transmitted by the base station transmitter via the downlink;
a remote unit transmitter configured to transmit data to the base station via an uplink, the remote unit transmitter capable of transmission at a selected one of a plurality of transmitter power levels;
a base station receiver configured to receive the data transmitted by the remote unit transmitter via the uplink, the transmitted data including a plurality of modulation level selection data bits indicating the selected modulation level selection for use by the base station;
a base station controller configured to select the modulation level for the base station transmitter to use on the downlink based on the modulation request data received from the remote unit; and
a remote unit controller configured to select a transmitter power level for the remote unit transmitter to use on the uplink based on the modulation level selection data bits.

15. The system of claim 14 wherein the remote unit controller is further configured to determine an error rate of data received from the base station, the remote unit controller being further configured to select the modulation level for downlink transmissions based on the determined error rate.

16. The system of claim 15 wherein error rate determined by the remote unit controller is a symbol error rate (SER).

17. The system of claim 14 wherein the remote unit transmitter is configured to transmit the modulation level request data to the base station.

18. The system of claim 17 wherein the remote unit transmitter is configured to transmit the modulation level data to the base station on every uplink data frame transmitted to the base station.

19. The system of claim 14 wherein the base station receiver is configured to receive the modulation level request data on a plurality of occasions wherein the base station controller is configured to select one of the plurality of modulation levels based on the modulation level request data received on at least one of the plurality of occasions.

20. A wireless communication system having a base station assigned to communicate with a plurality of remote units, the system comprising:
a base station transmitter configured to transmit data to ones of the plurality of remote units assigned to the base station via a respective downlink, the base station transmitter being capable of transmission using a selected one of a plurality of modulation levels;
a remote unit receiver at each of the remote units configured to receive the data transmitted by the base station transmitter via the respective downlink;
a remote unit transmitter at each of the remote units configured to transmit data to the base station via a respective uplink, each of the remote unit transmitters being capable of transmission at a plurality of transmitter power levels;
a base station receiver configured to receive the data transmitted by each of the remote unit transmitters via the respective uplink;
a base station controller configured to individually select a modulation level for the base station transmitter for transmission to each of the remote units wherein the modulation level for communication on each respective downlink is adaptively altered, and the base station transmission power level remains unchanged; and
a remote unit controller at each of the remote units configured to select a transmitter power level for each of the respective remote unit transmitters wherein the remote unit transmitter power level is adaptively altered, and the remote unit modulation level remains unchanged.

21. The system of claim 20 wherein the remote unit controller at each of the remote units is further configured to select a transmitter power level for the respective remote unit transmitter to use on the respective uplink based on the selected modulation level used on the respective downlink.

22. The system of claim 20 wherein the remote unit controller at each of the remote units is further configured to determine an error rate of data received from the base station, the remote unit controller being further configured to select the modulation level for downlink transmissions based on the determined error rate.

23. The system of claim 22 wherein the remote unit transmitter at each of the remote units is configured to periodically transmit the modulation level selection data to the base station on the respective uplink, the base station controller selecting the modulation level for communication on the respective downlink based on the modulation level selection data.

24. A communications protocol for use with a wireless communication system having a base station and a remote unit, the protocol comprising:
an uplink data message transmitted from the remote unit to the base station, the uplink data message including a header portion and a payload portion, the header portion comprising a plurality of modulation selection data bits indicating the selection of one of a plurality of modulation levels requested by the remote unit for downlink transmissions from the base station to the remote unit.

25. The protocol of claim 24 wherein the plurality of modulation selection data bits comprises two data bits to select from one of four possible modulation levels.

26. The protocol of claim 24 wherein the base station can transmit data on the downlink at a selected modulation level selected from a group of modulation levels comprising QPSK ½ rate CC, 16 QAM ½ rate CC, 64 QAM ½ rate CC, 64 QAM no CC, QPSK ½ CTC, QPSK ¾ CTC, 16 QAM ½ CTC, 16 QAM ¾ CTC, 64 QAM ½ CTC, 64 QAM ⅔ CTC, and 64 QAM ¾ CTC, wherein the plurality of modulation selection data bits select one of the modulation levels from the group of modulation levels.

27. A communications protocol for use with a wireless communication system having a base station and a remote unit, the protocol comprising:
a downlink data message transmitted from the base station to the remote unit, the downlink data message including a header portion and a payload portion, the header portion comprising a power control data bit to control transmission power by the remote unit when base station, the power control data bit being activated upon detection of external interference detected by the base station.

28. A method of operating a wireless communication system having a base station and a remote unit, comprising:
at the base station:
receiving data from the remote unit via an uplink, the data including modulation selection data;
adaptively selecting a modulation level for transmissions from the base station to the remote unit via a downlink based on the received modulation selection data; and
transmitting data to the remote unit via the downlink using the selected modulation level wherein transmission power level is not adaptively adjusted;
at the remote unit:
receiving data from the base station via the downlink;
analyzing the received data to determine a desired modulation level for future transmissions from the base station to the remote unit via the downlink;
adaptively selecting a transmission power level for transmission of data from the remote unit to the base station via the uplink based on the analysis of the received data; and
transmitting data to the base station via the uplink using the selected transmission power level wherein modulation level is not adaptively adjusted.

29. The method of claim 28 wherein analyzing the received data to determine a desired modulation level comprises determining an error rate of data received from the base station.

30. The method of claim 29 wherein adaptively selecting a transmission power level for transmission of data from the remote unit to the base station via the uplink comprises selecting a transmission power level based on the modulation level used on transmissions from the base station to the remote unit via the downlink.

31. The method of claim 28 wherein receiving data from the remote unit via the uplink comprises receiving a plurality of uplink messages from the remote unit wherein at least a portion of the plurality of uplink messages includes modulation selection data.

32. The method of claim 28 wherein receiving data from the remote unit via the uplink comprises receiving a plurality of uplink messages from the remote unit wherein each of the plurality of uplink messages includes modulation selection data.

33. The method of claim 28 wherein adaptively selecting a transmission power level for transmission of data from the remote unit to the base station via the uplink based on the analysis of the received data comprises selecting a transmission power level based on the modulation level used on transmissions from the base station to the remote unit via the downlink.

34. The method of claim 28 wherein adaptively selecting a transmission power level for transmission of data from the remote unit to the base station via the uplink comprises decreasing transmission power level for uplink transmissions if the selected modulation level for the downlink increases.

35. The method of claim 28 wherein adaptively selecting a transmission power level for transmission of data from the remote unit to the base station via the uplink comprises increasing transmission power level for uplink transmissions if the selected modulation level for the downlink decreases.

36. The method of claim 28 wherein adaptively selecting a modulation level for transmissions from the base station to the remote unit via a downlink based on the received modulation selection data comprises selecting a modulation level from a group of modulation levels comprising QPSK ½ rate CC, 16 QAM ½ rate CC, 64 QAM ½ rate CC, 64 QAM no CC, QPSK ½ CTC, QPSK ¾ CTC, 16 QAM ½ CTC, 16 QAM ¾ CTC, 64 QAM ½ CTC, 64 QAM ⅔ CTC, and 64 QAM ¾ CTC.

37. The method of claim 28 wherein the remote unit comprises a consumer premise equipment (CPE).
